(19) United States
(12) Patent Application Publication
(10) Pub. No.: US 2019/0392402 A1
(43) Pub. Date: Dec. 26, 2019

(54) ADAPTIVE MAINTENANCE OF A PRESSURIZED FLUID CUTTING SYSTEM

(71) Applicant: HYPERTHERM, INC., Hanover, NH (US)

(72) Inventors: Cedar Vandergon, Hanover, MN (US); David Osterhouse, New Brighton, MN (US); Steven Voerding, New Brighton, MN (US); Sara Mancell Mancell, Ham Lake, MN (US); Paul T Fransen, Mounds View, MN (US); Kimberly Catten Ely, St Paul, MN (US); Jon Lindsay, Grantham, NH (US); Garrett Quillia, Enfield, NH (US); Brett Hansen, Mapleton, UT (US)

(21) Appl. No.: 16/017,883

(22) Filed: Jun. 25, 2018

(51) Int. Cl. G06Q 10/00; B26D 7/08; B24C 1/04; B23P 6/00

(52) U.S. Cl. CPC G06Q 10/20; B23P 6/00; B24C 1/045; B26D 7/08

(57) ABSTRACT

Provided is an adaptive maintenance system of a pressurized fluid cutting system including methodological aspects of generating a service part replacement criteria for a part of the pressurized fluid cutting system and setting forth a protocol to manage maintenance of the pressurized fluid cutting system.

### BACKGROUND

### Technical Field

This disclosure relates generally to maintenance of pressurized fluid cutting systems and more particularly to adaptive maintenance of pressurized fluid cutting systems via monitoring, detection and/or prediction of failures (or triggers) by an intelligent maintenance system.

### State of the Art

Pressurized fluid cutting systems, such as waterjet cutting systems, typically require regular maintenance to help keep the systems operating effectively. Various components of pressurized fluid cutting systems have different life durations and parts can, at times, fail with little warning. To avoid unwanted part failure, maintenance schedules are often established to service or replace parts on an ongoing and regular basis. However, maintenance of a pressurized fluid cutting system commonly requires downtime. To minimize downtime, it is desirable to service or replace all parts in need of, or soon to be in need of, service or replacement during a single downtime period, so that separate additional downtime periods are not required to service and replace each applicable component part of a pressurized fluid cutting system. When a part is replaced, any remaining lifespan of the part is lost, so it is desirable to maximize part lifespan, while balancing the risk, over time, of potential part failure. Moreover, it is also desirable to maintain the effective operability of pressurized fluid cutting systems in a controlled and predictable manner that minimizes unscheduled downtime. Hence, there is a need for an adaptive maintenance system that monitors part lifespan, determines part failure, and adjusts a corresponding maintenance schedule based upon measured and/or predicted health of pressurized fluid cutting system components by an intelligent system operable according to user-controllable failure risk levels, to optimize service and replacement of pressurized fluid cutting system parts and to minimize downtime.

### SUMMARY

An aspect of the present disclosure provides a method of generating a service part replacement criteria for a part of a pressurized fluid cutting system, the method comprising: providing a first service part of a pressurized fluid cutting system; assigning an initial service score for the first service part; measuring an operating condition of the pressurized fluid cutting system associated with the first service part; and assigning a modified service score of the first service part based upon the measured operating conditions of the pressurized fluid cutting system.

Another aspect of the present disclosure provides a service protocol for a pressurized fluid cutting system, comprising: presenting a user, by a computer interface associated with the cutting system, with one or more service thresholds; receiving a user input of a selected service threshold; identifying a failure event of a first part; based upon the selected service threshold, designating one of a first set of parts or a second set of parts to be serviced; wherein the first set of parts to be serviced is associated with a first service threshold and the second set of parts to be serviced is associated with a second service threshold, and wherein the first set of parts is different than the second set of parts; and indicating to the user the designated first or second set of parts that fall within the selected service threshold.

Still another aspect of the present disclosure provides a service management system for a pressurized fluid cutting system, comprising: providing a pressurized fluid cutting system having a plurality of service parts; establishing a first scheduled maintenance event for servicing a first set of parts; establishing a second scheduled maintenance system for servicing a second set of parts; identifying a failure of a part of the first set of parts prior to the first scheduled maintenance event; modifying the first scheduled maintenance event to coincide with the failure of the part of the first set of parts, based upon a service score; and modifying the second maintenance event based upon the modified first scheduled maintenance event.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members:

FIG. 1 depicts a table setting forth an example of a prior art pressurized fluid cutting system maintenance schedule;

FIG. 2 depicts an embodied representation of a maintenance visualization for a pressurized fluid cutting system, in accordance with the present disclosure;

FIG. 3 depicts an example of an adapted maintenance schedule based upon an operator selecting and executing the maintenance prompted by the Low Risk profile shown in FIG. 2, in accordance with the present disclosure;

FIG. 4 depicts a maintenance chart embodying a continuation of the maintenance scheduling associated with the High Risk profile shown in FIG. 2, in accordance with the present disclosure;

FIG. 5 depicts embodiments of two potential service scores (represented visually by bell curves) corresponding to a part of a pressurized fluid cutting system, as determined by factors possibly associated with that part; and

FIG. 6 depicts an embodied representation of charted visual service scores corresponding to various parts of a pressurized fluid cutting system over a certain time period, wherein some of the parts are monitored by sensors, in accordance with the present disclosure.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

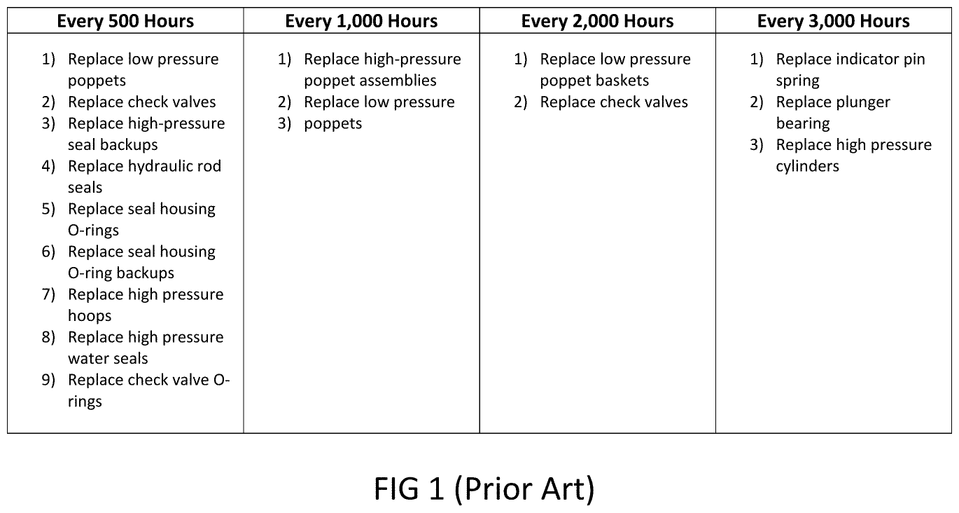

Maintenance schedules for pressurized fluid cutting systems are commonly set based upon hours of operation. For example, FIG. 1 depicts a table setting forth an example of a conventional pressurized fluid cutting system maintenance schedule, as known to those of ordinary skill in the requisite art. An operator can replace different parts according to the maintenance schedule depicted in FIG. 1. Yet, following the schedule precisely can often be cumbersome to manage, as different parts might fail at different times, and if an operator does not follow the recommended schedule closely enough part lifespan can be lost and/or system downtime may extend longer than is necessary. What can contribute to the difficulty is when a component of a pressurized fluid cutting system fails prior to the recommended replacement schedule. For instance, if a check valve fails at 1,800 hours (200 hours prior to its scheduled maintenance) the operator of a common pressurized fluid cutting device may need to determine whether components that are to be replaced every 500 hours and every 1,000 hours likewise should be replaced at the 1,800-hour mark, so that downtime can be minimized. If the operator only replaces the faulty check valve, there is a potential for additional components to fail only a short time later and the operator may be forced to make another maintenance stop, for example in a mere 200 hours, which could incur costly machine downtime. But, in the converse, if the operator chooses to utilize the requisite downtime to replace every part suggested for replacement during the next scheduled maintenance then significant lifespan of many of the replaced parts may be lost. Hence, balancing whether to adapt a modified maintenance schedule and throw away remaining part lifespan against increasing potential for part failure over time, especially when a plurality of parts are scheduled for future replacement, can be extremely complicated.

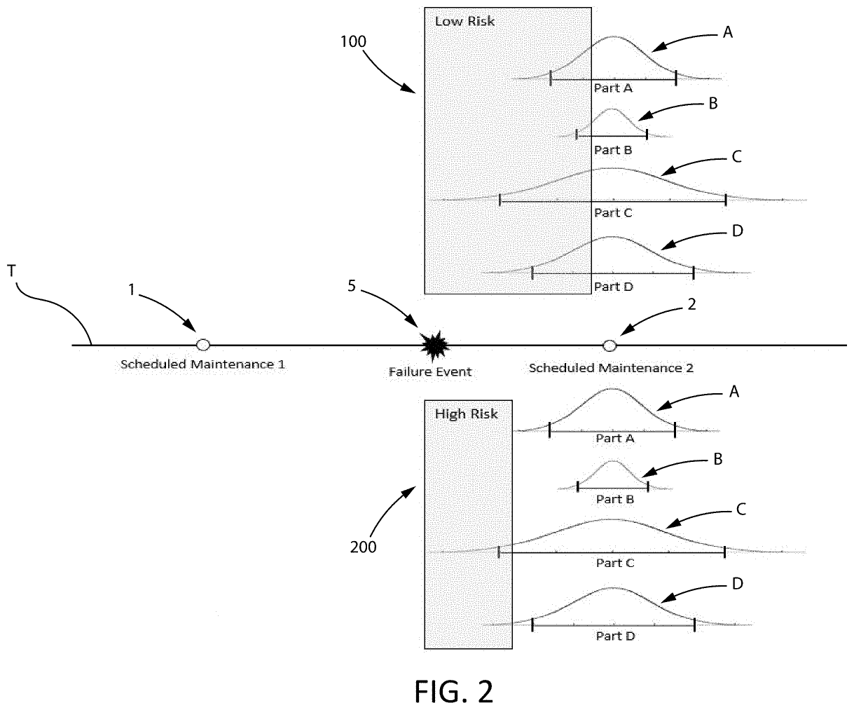

The present disclosure provides, inter alia, data driven methodology to identify and manage what parts of a pressurized fluid cutting system are more efficient to replace for a given maintenance event. Parts that commonly are replaced are parts such as a check valve, a low-pressure poppet, a high-pressure cylinder, a high-pressure seal back-up, a hydraulic rod seal, a seal housing O-ring, a seal housing O-ring back-up, a high-pressure hoop, a high-pressure water seal, a check valve O-ring, a high-pressure poppet assembly, a low-pressure poppet retainer, an indicator pin spring and/or a plunger bearing and/or other pressurized fluid cutting system parts. Referring to the drawings, FIG. 2 depicts an embodied representation of a maintenance visualization for a pressurized fluid cutting system. Along the horizontal time axis line T are two Scheduled Maintenance events, a First Scheduled Maintenance 1 and a Second Scheduled Maintenance 2. At Second Scheduled Maintenance 2, as depicted, parts A, B, C and D are scheduled to receive service, replacement, or some form of maintenance. As different parts have a different predictability and precision of repair and replacement, a corresponding bell curve for scoring the need to service each of the parts may be slightly different for each part. Determination of the size of the bell curve corresponding to the need to service each part will be described in greater detail later on. The top half of FIG. 2 (above the time axis line T) pertains to a Low Risk 100 service profile whereas the bottom half pertains to a High Risk 200 service profile.

Referring further to FIG. 2, the depicted maintenance visualization, as embodied, pertains to a point in time between the First Scheduled Maintenance 1 and the Second Scheduled Maintenance 2. Those in of ordinary skill in the art should appreciated that a maintenance checklist may be generated regarding any point or period of time. After completion of First Scheduled Maintenance 1 (details of any component parts that may have been serviced or replaced are not shown) the system will continue to operate with an anticipated Second Scheduled Maintenance 2 event forthcoming. However, in some circumstances, despite scheduled maintenance for a pressurized fluid cutting system, a Failure Event 5 may occur. For the purposes of this disclosure, a Failure Event 5 may be a user diagnosed error, such as a human operator of the system seeing a leaking seal or some other failing part. The user may then initiate a signal identifying the discovered Failure Event 5. In addition, the Failure Event 5 may be a signal generated by a monitoring sensor, such as a temperature sensor that may send a signal if an inappropriate temperature reading is detected, or a drip detection sensor that sends a signal if an unacceptable amount of fluid is detected in a system location. Moreover, the Failure Event 5 may be signal from a system component that counts and records the operation cycles or usage time of a given part, wherein that part has reached a certain number of system cycles or amount of usage time and has, therefore, reached or is near to a predicted end-of-life.

When a Failure Event 5 is detected outside of a scheduled maintenance window, the system may conduct an evaluation of the different parts, such as parts A through D, to see if it would be efficient and desirable to replace other parts, during maintenance downtime shortly following the Failure Event 5, rather than at the forthcoming Second Scheduled Maintenance 2 event. Such an evaluation of the status of the system components may include the system querying a database containing data about parts that are getting near to their end-of-life. A graphical depiction of the results of such a query may reveal maintenance information similar to the embodiment of the maintenance chart shown in FIG. 2. As depicted, each of the component parts, such as parts A through D, that are scheduled for maintenance during the upcoming Second Scheduled Maintenance 2 event have corresponding performance prediction bell curves visually positioned perpendicular to the time axis line 5, at the location of the Second Scheduled Maintenance 2. The closer the left end of a plotted bell curve corresponding a part scheduled for upcoming maintenance is to the Failure Event 5, the nearer a future predicted failure event pertaining to that part may be. Hence, with regard to the maintenance chart embodiment shown in FIG. 2, Part C is closer to predicted failure than is Part B.

Intelligent and adaptive maintenance scheduling may permit an operator of a pressurized fluid cutting system to choose a maintenance risk profile for the system. If there is a low risk tolerance for machine downtime, the user may select a “Low Risk” profile 100 such as is shown in the top portion of FIG. 2, above the time axis line T. For example, a job shop which is very busy and has high machine demand and a very low tolerance for machine down time may want to select a Low Risk profile 100. However, if an operator of a pressurized fluid cutting system has a higher tolerance for risk, the operator may select a profile similar to the “High Risk” profile 200 depicted in the bottom half of FIG. 2, below the time axis line T. In essence, a Low Risk profile 100 will tend to prompt replacement of parts at a more frequent interval than a High Risk profile 200. Thus, a Low Risk profile 100 user can more predictably ensure that when a pressurized fluid cutting system is stopped due to a Failure Event, the system is repaired such that it is unlikely to fail in the near term. A High Risk profile 200 user, to the contrary, may replace fewer parts during a likely shorter downtime maintenance period, such as, for example, replacing only the failed part and those parts that are eminently failing, thereby leaving other parts to be replaced at a later scheduled maintenance event. The High Risk profile 200 or Low Risk profile may be selected before or after the Failure Event 5.

With further reference to FIG. 2, when in a Low Risk profile 100, the system may look at a broader range of parts that are near failure from the reference point of the Failure Event 5. This is demonstrated by the shaded box that visually corresponds to the Low Risk profile 100. The tolerance for risk is lower, so the box corresponding to when parts may need to be serviced/replaced is bigger. Hence, if any significant portion of the bell curves associated with parts scheduled for upcoming maintenance fall within the Low Risk profile 100 window (the shaded box of FIG. 2) a prompting would be generated to suggest replacing or servicing those parts during the downtime of the Failure Event 5. As such, in the embodied Low Risk profile 100 scenario of the maintenance chart shown in FIG. 2, parts A through D would all be replaced. Similarly, for the High Risk profile 200, any parts (or rather significant portions of the failure prediction bell curves of any parts) that fall within the High Risk profile 200 window would be replaced. In the scenario embodied in FIG. 2, this would be only Part C. Thus, an operator may be able to customize the maintenance profile for a pressurized fluid cutting system, such that the maintenance profile intelligently corresponds to the operator's designated risk tolerance.

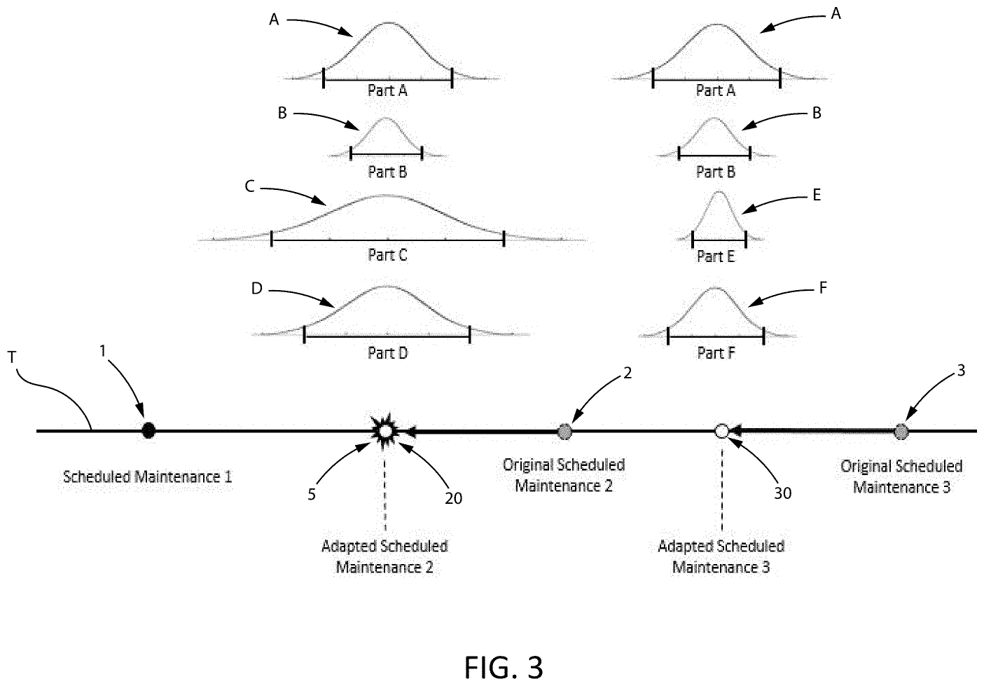

With further reference to the drawings, FIG. 3 depicts an example of an adapted maintenance schedule based upon an operator selecting and executing the maintenance prompted by the Low Risk profile shown in FIG. 2. After the operator has performed the maintenance for either the High Risk 200 or Low Risk 100 profiles at the time of the Failure Event 5, the system will create a new adapted maintenance schedule based upon the service that was completed at or near the time of the Failure Event 5. Hence, because parts A through D were replaced at the time of the Failure Event 5, a new Adapted Second Scheduled Maintenance 20 is created to reflect the maintenance associated with the original Second Scheduled Maintenance 2 that was performed early, during the downtime associated with the Failure Event 5. In addition, a new Adapted Third Scheduled Maintenance 30 is created so that the duration between maintenance events does not increase the chance of a part failing prior to a scheduled maintenance event. Thus, the system replaces the original Third Scheduled Maintenance 3 with an Adapted Third Scheduled Maintenance 30 which is time-shifted to the left (i.e. sooner) than the original Scheduled Maintenance date. This adaptive shifting of Scheduled Maintenance is performed for all future Scheduled Maintenance events.

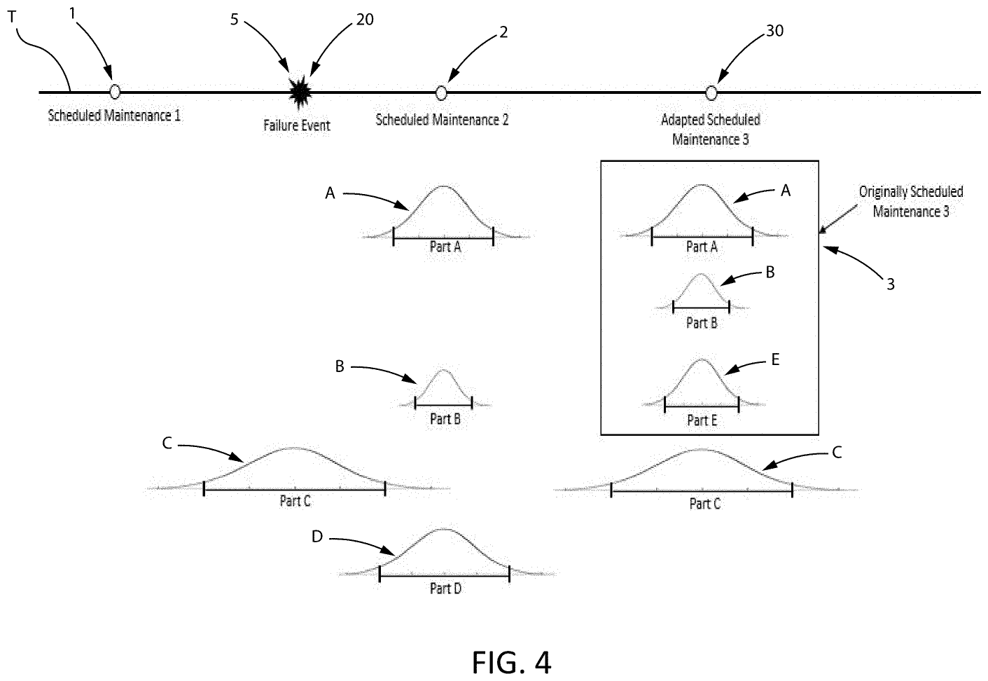

The Adapted Third Scheduled Maintenance 30 may require the service of the same or different parts from that of the Adapted Second Scheduled Maintenance 20. The parts that are selected for service/replacement during the Adapted Third Scheduled Maintenance 30 may depend upon which parts were serviced/repaired during the Adapted Second Scheduled Maintenance 20 event. This can be demonstrated further by continued reference to FIGS. 1-3 and additional reference to FIG. 4, which depicts a maintenance chart embodying a continuation of the maintenance scheduling associated with the High Risk profile 200 shown in FIG. 2. As set forth by the High Risk 200 maintenance window, only part C was replaced at the Failure Event 5 (along with the servicing and/or replacing of the part (undisclosed) that triggered the Failure Event 5), thereby requiring that parts A, B, and D keep the originally scheduled maintenance event (Second Scheduled Maintenance event 2). In this scenario, the original Third Scheduled Maintenance 3 would maintain its same time interval (usually based on hours of operation of the pressurized fluid cutting system), but additional parts may be added to the event. In the example of FIG. 4, original Third Scheduled Maintenance 3 could include parts A, B, and E. However, because part C, was replaced during the Failure Event 5 (corresponding to Adapted Second Scheduled Maintenance 20) and earlier than predicted, part C may be added to the Adapted Third Scheduled Maintenance 30. This way, the intelligent maintenance system may adapt outside of a predetermined maintenance schedule to accommodate for the real-world servicing that is done outside of typical scheduled maintenance. Thus, the adaptive maintenance schedule may allow the system to have fewer periods of downtime stoppage and less overall service events, thereby resulting in savings of time and money as system maintenance is intelligently managed.

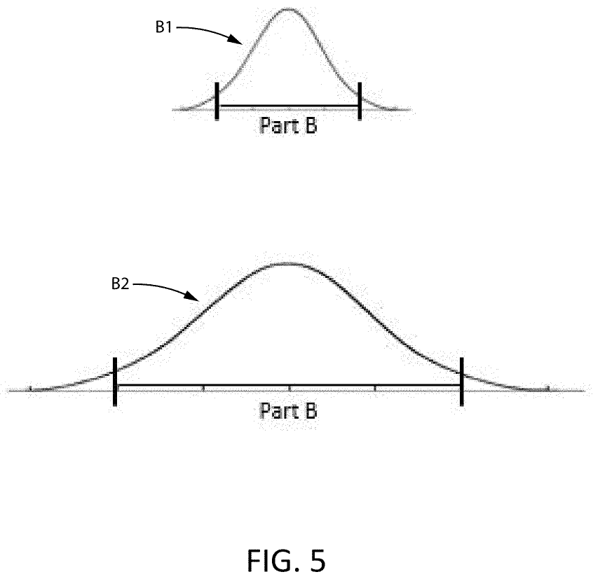

With continued reference to the drawings, FIG. 5 depicts embodiments of two potential service scores (represented visually by bell curves B1 and B2) corresponding to a part B of a pressurized fluid cutting system, as determined by factors possibly associated with that part B. Each component part of a pressurized fluid cutting system may be given a service score. A service score may be visually depicted by a bell curve. A wider bell curve may correspond to a part that may be more desirable or ready for servicing and/or replacement. A bell curve with a narrower profile may correspond to a part that is less desirable or in lesser need to be serviced and/or replaced. Various factors or replacement criteria may enter into the determination of a service score (or contribute to the visual width of the corresponding bell curve). Some of the factors may be, but are not limited to, predicted life of the applicable component part, detected conditions of the part (by a human operator and/or by sensors), price of a replacement part, ease of replacement of the part, and/or opportunity to access the part when potentially servicing another part. For instance, a part, such as a part B, that may be experiencing a detected increase in drip count, although the increase in drip count may not place the part B into failure realm, that is also relatively inexpensive and easy to replace may receive a wide bell curve B1. This wider bell curve B1 may make the part B more likely to fall within a service event when another part is being serviced or replaced. By contrast, if part B was a more expensive component and/or was more difficult to service or replace then the bell curve B2 corresponding to part B would be significantly narrower, thereby prompting scheduled replacement of the part B only when it is much more necessary.

Each of the factors or replacement criteria applicable to service score determination may be weighted or otherwise assigned how much affect upon the width of a bell curve the factor may have. The metrics how the factors are weighted into scoring may change depending on conditions potentially associated with use of a pressurized fluid cutting system. For example, if part B is a low-cost part that is also extremely difficult to replace then scoring metrics may be assigned to part B such that the difficulty of replacement factors much more heavily into bell curve creation than the low cost. Such a bell curve may have a narrower profile, like bell curve B2. Yet, the scoring metrics may be adaptively changed if a Failure Event 5 involves replacing another part that perhaps makes accessing and replacing part B easier. In such an instance, the corresponding bell curve may have a wider profile, like bell curve B1. Alternatively, or in conjunction, rather than simply viewing the service range of a part as a bell curve, the part, such as part B, may simply receive a score where all the factors pertinent to the determination of needed service are given a number. The number may be weighted according to adaptive metrics. This composite score of the pertinent factors can be compared against a service threshold. In this process, parts with a composite service score above the threshold would be prompted for replacement and parts below the threshold would not. For example, a high-priced seal may receive a price score of 2 points, an ease of access score of 4 points, and predicted life score of 8 points. The composite service score of the seal would therefore be 14 points. If the numeric replacement threshold is set at 15 points, the seal would not be prompted for replacement, since its composite service score, at that time, failed to reach the replacement threshold of 15 points. However, if after a Failure Event 5, the adaptive metrics contribute to the modification of the ease of access score, because another part makes accessing the seal much easier, a new point value of 8 points may be assigned, thereby increasing the total composite service score to 18 points. At which point, a prompt for service/replacement of the seal may be generated by the intelligent adaptive maintenance system, because the composite service score of the seal is above the set threshold of 15 points.

Service thresholds may be set or modified in accordance with risk designations. For example, a Low Risk profile 100 would set part service point thresholds comparatively lower than the thresholds that would be set for a High Risk profile 200. Service thresholds may also correspond to “zones” or portions of a pressurized fluid cutting device, wherein a zone contains several parts that are more efficiently replaced all at once when a maintenance event affecting that “failure zone” occurs. Thus, adaptation of maintenance based on service scoring may incorporation replacement criteria pertaining to failure zones.

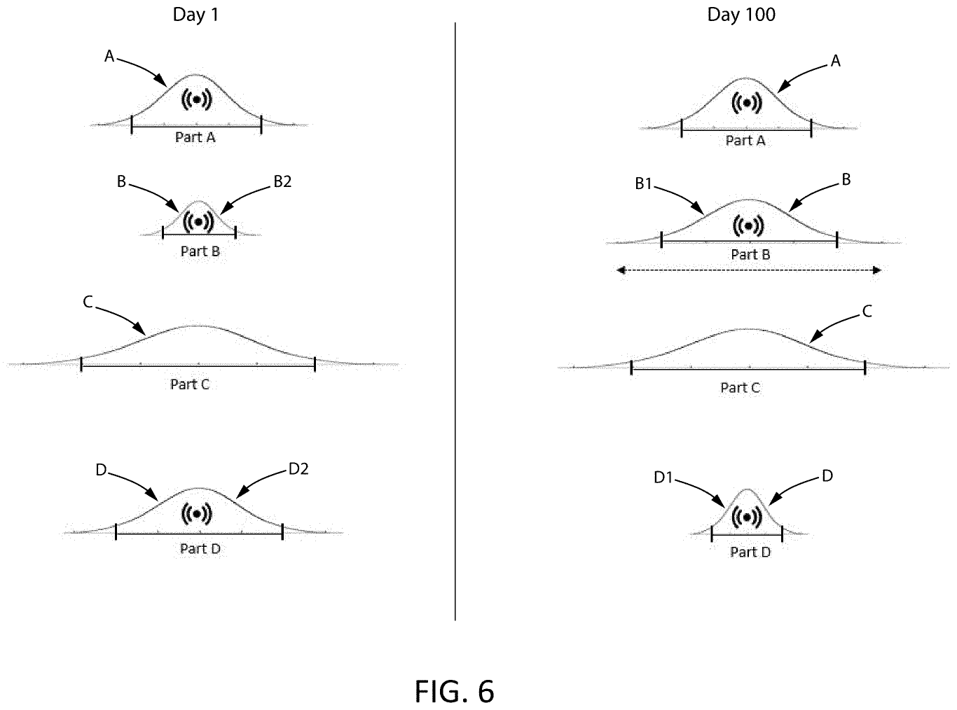

With still further reference to the drawings, FIG. 6 depicts an embodied representation of charted visual service scores corresponding to various parts of a pressurized fluid cutting system over a time period, such as 100 days, wherein some of the parts are monitored by sensors. Various component parts of a pressurized fluid cutting system may be effectively, economically and efficiently monitored by sensors, wherein the sensors may measure the operating condition of applicable parts and detect any abnormalities. As shown in FIG. 6, parts A, B, and D are connected to, or otherwise monitored by, sensors. The sensors may measure part performance and generate monitoring data. This monitoring data may be utilized when determining and assigning a service score of a part, such as part B, at any given time. Monitoring of part functionality during operation of a pressurized fluid cutting system may facilitate variable service scores. The monitoring data may also be the means, or at least a part of the means, by which a Failure Event, such as Failure Event 5, may be detected. By actively measuring operating conditions of various parts with the sensors, a monitored part which is not above a set service replacement threshold, but is showing signs and measurements indicating significant wear, may have the corresponding service score adaptively modified so that the service score is varied so as to more likely or less likely to prompt replacement of the part at the next service event. An example of such a modified service score may be visually illustrated by the corresponding service score bell curve of the part, such as part B, getting wider, like bell curve B1, over a time period, such as 100 days, and indicating that part B may be failing faster than predicted. A contrast can be made in the adaptive scoring change of part D, as compared to part B, where, at Day 100, the bell curve corresponding to part D is narrowing, because the applicable sensor is indicating proper function suggesting that part D will last longer than originally scheduled. Thus, by use of sensors, the system's intelligent maintenance schedule may be adapted in near real time to keep the system functioning properly and minimize costly downtime.

There are times when an intelligent maintenance system, as disclosed herein may automatically adjust to and adapt a pressurized fluid cutting system based upon actual service events and/or a user selected risk profile. In such times, there is a potential for the system to prompt replacement of parts that may still have remaining life or durable use. For example, second service part may be provided for replacement, as selected based on a second modified service score. This may be especially true for situations where a user wants to reduce costs and where downtime is acceptable. Despite the user being focused more on cost, the user may also prefer to have a system that has new parts and is operating correctly. It may be not only cheaper to replace a still functioning part early, rather than perform repeated maintenance as parts fail, but also may instill operational peace of mind. However, cost can sometimes be a barrier that makes it difficult to replace still-working parts. Therefore, another aspect of an adaptive maintenance plan may be to credit a user back a portion of the cost of a replaced part that remains unused after the part's replacement. For example, if a seal is expected to last 1,000 hours, but following a prompt by the intelligent adaptive maintenance system, a user replaces the seal at the 600-hour point because it is convenient in view of current maintenance events, the user may be given a credit for the unused life of the part. The hours of usage could be stored on RFID tags. In this example, the user may receive a 40% credit of the cost of the seal towards a new part. This way the user has much less incentive to not replace parts that are convenient to be replaced during a service event. Additionally, where sensors are able to verify that service and/or replacement has been performed, the warranty on the pressurized fluid cutting system may be automatically extended in a corresponding manner, when proper preventive maintenance is performed on the pressurized fluid cutting system, as confirmed by monitoring sensors.

Intelligent maintenance of a pressurized fluid cutting system may involve the implementation of a service protocol provided to adaptively regulate system maintenance. Under such a service protocol, a failure event, such as Failure Event 5, may be identified, either by a monitoring sensor or by a user noticing something awry about a part of the pressurized fluid cutting system. The failure event may involve the failure of a first part, such as part A, of the pressurized fluid cutting system. When a failure event is detected, the user may be presented with service options pertaining to one or more service thresholds, such as a High Risk profile 200 maintenance schema and/or a Low Risk profile 100 maintenance schema. The presentation to the user of the service options may be by computer interface associated with the pressurized fluid cutting system. A first service threshold may be presented to the user suggesting service of a first set of parts, such as parts A, B, C and D, as depicted in FIGS. 2 and 3. A second service threshold may be presented to the user suggesting service of only part C, as depicted in FIGS. 2 and 4. The user may be able to tell from the presentation of the service options that the first set of parts may be different than the second set of parts. The service protocol may then call for the system to receive an input from the user of a selected service threshold, such as either the Low Risk profile 100 or the High Risk profile 200. Based upon the user's selected and inputted service threshold, the system may designate one of the first set of parts, such as parts A, B, C and D, or the second set of parts, such as part C to be serviced, in respective correlation with the user's selected service threshold, such as the Low Risk profile 100 or the High Risk profile 100.

It may be important for the user to understand the ramifications of the selected service threshold upon scheduled maintenance of the system. The protocol may, therefore, dictate that the system (likely through the computer interface) indicate to the user the designated first or second set of parts that may fall within the user's selected service threshold. Thus, if the user selects and inputs a Low Risk profile 100 the system may indicate that parts A, B, C and D would be up for service/replacement during the scheduled maintenance event (the Adapted Second Scheduled Maintenance event 20). Moreover, if the user selects and inputs the High Risk profile 200 the system may indicate that only part C would be up for service/replacement during the scheduled maintenance event (the differently Adapted Second Scheduled Maintenance event 20). After the scheduled maintenance, such as the Adapted Second Scheduled Maintenance 20, occurs, the system may, through monitoring sensors, be able to determine whether and which parts may have been serviced/replaced during the maintenance event. In addition, the user may input which parts may have been serviced/replaced. With the information regarding which parts were serviced, the intelligent system can again adapted the maintenance schedule so that future maintenance may be optimized.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. A method of generating a service part replacement criteria for a part of a pressurized fluid cutting system, the method comprising:
providing a first service part of a pressurized fluid cutting system;
assigning an initial service score for the first service part;
measuring an operating condition of the pressurized fluid cutting system associated with the first service part; and
assigning a modified service score of the first service part based upon the measured operating conditions of the pressurized fluid cutting system.

2. The method of claim 1, wherein the first service part is provided from the group consisting of:
a check valve;
a low-pressure poppet;
a high-pressure cylinder;
a high-pressure seal back-up;
a hydraulic rod seal;
a seal housing O-ring;
a seal housing O-ring back-up;
a high-pressure hoop;
a high-pressure water seal;
a check valve O-ring;
a high-pressure poppet assembly;
a low-pressure poppet retainer;
an indicator pin spring; or
a plunger bearing.

3. The method of claim 1, wherein the service score is determined by a plurality of factors, wherein the factors may be considered separately or in various combinations.

4. The method of claim 4, wherein the plurality of factors are considered from two or more of the group consisting of:
predicted life of the part;
measured operating conditions;
part price;
ease of part replacement; or
opportunity for part replacement.

5. The method of claim 5, wherein the initial service score becomes the modified service score based on at least one of the factors.

6. The method of claim 6, wherein the modified service score corresponds to a measured condition determined by input from a monitoring sensor.

7. The method of claim 5, further comprising modifying the modified service score to become a second modified service score based on at least one of the factors.

8. The method of claim 1, further comprising the steps of:
measuring a second operating condition of the pressurized fluid cutting system associated with the first service part; and
assigning a second modified service score of the first service part based upon the second measured operating conditions of the pressurized fluid cutting system.

9. The method of claim 8, wherein a second service part is provided from the parts as set forth in claim 2 and as selected based on the second modified service score.

10. A service protocol for a pressurized fluid cutting system, comprising:
presenting a user, by a computer interface associated with the cutting system, with one or more service thresholds;
receiving a user input of a selected service threshold;
identifying a failure event of a first part;
based upon the selected service threshold, designating one of a first set of parts or a second set of parts to be serviced;
wherein the first set of parts to be serviced is associated with a first service threshold and the second set of parts to be serviced is associated with a second service threshold, and
wherein the first set of parts is different than the second set of parts; and
indicating to the user the designated first or second set of parts that fall within the selected service threshold.

11. The service protocol of claim 10, wherein the step of identifying includes receiving an input from a user identifying the failure event.

12. The service protocol of claim 10, wherein the step of identifying includes receiving an input from a monitoring sensor determining the failure event.

13. The service protocol of claim 10, wherein the step of selecting a service threshold occurs after the step of identifying a failure event.

14. The service protocol of claim 10, wherein there is a third set of parts associated with a selection of a third service threshold.

15. The service protocol of claim 10, wherein the determination of which parts comprise a set of parts is based upon one or more factors including:
predicted part life;
measured operating conditions;
part price;
ease of part replacement; and
opportunity for part replacement.

16. The service protocol of claim 10, wherein one or more of the parts of the first set of parts and the second set of parts have a variable service score relative to the selected threshold,
wherein parts that have a score that is above the threshold get replaced, and
wherein services scores are variable based upon sensor measurement of the parts.

17. A service management system for a pressurized fluid cutting system, comprising:
providing a pressurized fluid cutting system having a plurality of service parts;
establishing a first scheduled maintenance event for servicing a first set of parts;
establishing a second scheduled maintenance system for servicing a second set of parts;
identifying a failure of a part of the first set of parts prior to the first scheduled maintenance event;
modifying the first scheduled maintenance event to coincide with the failure of the part of the first set of parts, based upon a service score; and
modifying the second maintenance event based upon the modified first scheduled maintenance event.

18. The system of claim 17, wherein the service score is based upon a user-selected threshold pertaining to risk of future part failure.

19. The system of claim 18, wherein a lower risk threshold determines a service score that prompts more regular part service.

20. The system of claim 17, further comprising a user interface configured to identify which parts are to be serviced during a scheduled maintenance event.

21. The system of claim 20, wherein the user interface is configured to allow a user to input identification of a failed part, wherein the identification of a failed part comprises a failure event.

22. The system of claim 17, wherein a sensor identifies the failure of the part of the first set of parts prior to the first scheduled maintenance event.
